(19) United States
(12) Patent Application Publication
(10) Pub. No.: US 2026/0346591 A1
(43) Pub. Date: Nov. 5, 2026

(54) GAS BARRIER MULTILAYER FILM

(71) Applicant: LG CHEM, LTD, Seoul (KR)

(72) Inventors: Jun Geun UM, Daejeon (KR); Jaeyong PARK, Daejeon (KR); Moonsoo KIM, Daejeon (KR); Chunhwa LEE, Daejeon (KR); Moon Gon JEONG, Daejeon (KR)

(21) Appl. No.: 19/124,609

(22) PCT Filed: Jul. 15, 2024
(86) PCT No.: PCT/KR2024/010081

§ 371 Date: Apr. 25, 2025

(30) Foreign Application Priority Data
Jul. 20, 2023 (KR) 10-2023-0094875

(51) Int. Cl. B32B 27/36; B32B 9/00; B32B 9/04; B32B 27/08

(52) U.S. Cl. CPC B32B 27/36; B32B 9/005; B32B 9/045; B32B 27/08; B32B 2250/02; B32B 2250/244; B32B 2307/7163; B32B 2307/7244; B32B 2307/7246; B32B 2307/7376; B32B 2439/70

(57) ABSTRACT

A gas barrier multilayer film according to the present disclosure is biodegradable and, at the same time, has excellent gas barrier properties. When applied to food packaging materials, the gas barrier multilayer film has the advantage of enabling long-term storage and distribution of food due to its excellent gas barrier properties. In addition, due to its characteristic of being biodegradable in soil and marine conditions, the gas barrier multilayer film can be utilized as a biodegradable eco-friendly packaging material.

### CROSS-REFERENCE TO RELATED APPLICATION(S)

This application is a National Phase entry pursuant to 35 U.S.C. 371 of International Application PCT/KR2024/010081 filed Jul. 15, 2024, which claims the benefit of Korean Patent Application No. 10-2023-0094875 filed on Jul. 20, 2023 in the Korean Intellectual Property Office, the disclosure of which is incorporated herein by reference in its entirety.

The present disclosure provides a multilayer film which is eco-friendly and has gas barrier properties.

### BACKGROUND

Natural disasters which have been frequently occurring in recent years have led to the recognition that environmental pollution and climate change are serious issues that must be addressed as a top priority. Among these, the reduction in the use of disposable plastics is a policy being pursued by several countries as an environmental pollution improvement activity capable of being practiced on a daily basis.

As part of this policy, the use of eco-friendly or biodegradable plastics is also recommended, and various plastics that can be biodegraded in soil or ocean are being researched and developed. However, in the case of food packaging which occupies a majority of plastic, it is essential to use materials that can block gases such as oxygen and moisture in order to prevent food from denaturing during distribution and preserve the food for a long time. Since most gas barrier materials are petrochemical-based, these gas barrier materials cannot be biodegraded. Therefore, in order to realize eco-friendly food packaging materials that use biodegradable materials, food packaging companies generally add a metal layer to impart barrier properties, or preferentially apply biodegradable plastic materials to products that do not require barrier properties.

### SUMMARY

Therefore, the present disclosure is directed to a to a multilayer film capable of blocking oxygen and moisture based on PGA (poly(glycolic acid)), which is a biodegradable polymer material. The present disclosure confirms that biodegradable food packaging is possible through such a multilayer film.

### DETAILED DESCRIPTION

It is an object of the present disclosure to provide a multilayer film which is eco-friendly and has gas barrier properties.

It is another object of the present disclosure to provide a method of manufacturing a gas barrier multilayer film.

In order to achieve the above objects, according to the present disclosure, there is provided a gas barrier multilayer film as follows.

A gas barrier multilayer film comprising a substrate layer (Ts); and a gas barrier layer (Tb) formed on the substrate layer,
where the gas barrier layer (Tb) comprises 40 to 60 vol % of poly(glycolic acid) (PGA) based on the total volume of the gas barrier layer, and
the gas barrier multilayer film satisfies the following Mathematical Formula 1:

0.38≤D(Tb)/D(Ts)<4.89 [Mathematical Formula 1]
where
D(Tb) is the thickness of the gas barrier layer, and
D(Ts) is the thickness of the substrate layer.

The gas barrier multilayer film of the present disclosure comprises at least two layers: a substrate layer (Ts); and a gas barrier layer (Tb) formed on the substrate layer. Among the two layers, the gas barrier layer (Tb) may comprise poly(glycolic acid) (PGA) as a biodegradable polymer, thereby making the gas barrier multilayer film biodegradable and eco-friendly. The gas barrier layer and the substrate layer complement each other to exhibit excellent gas barrier properties.

The present disclosure will be described in detail below.

The term “gas barrier layer (Tb)” as used herein means a layer containing 40 to 60 vol % of poly(glycolic acid) (PGA) based on the total volume of the gas barrier layer. The poly(glycolic acid) is a biodegradable polymer, so that the gas barrier multilayer film according to the present disclosure can be used in an eco-friendly manner. If the content of the poly(glycolic acid) included in the gas barrier layer is less than 40 vol %, it is difficult to realize an effective gas barrier effect, and if the content of the poly(glycolic acid) included in the gas barrier layer exceeds 60 vol %, there is a problem that the melt processability is reduced and the decomposition phenomenon of the poly(glycolic acid) is aggravated during processing.

Preferably, the weight average molecular weight (Mw) of the poly(glycolic acid) is 80,000 to 220,000. When the weight average molecular weight of the poly(glycolic acid) is less than 80,000, there may be a problem that extrusion molding is difficult due to low melt viscosity, and the mechanical properties of the molded product, such as a molded film, are not sufficient. In addition, when the weight average molecular weight is higher than 220,000, the poly(glycolic acid) may discolor significantly, which may cause an appearance problem of the molded product, such as a film, and more energy may be required for melt processing, making efficient processing difficult. More preferably, the weight average molecular weight (Mw) of the poly(glycolic acid) is 100,000 to 200,000.

Preferably, the molecular weight distribution (polydispersity Index, PDI) of the poly(glycolic acid) is 1.5 to 4.5. The molecular weight distribution of the poly(glycolic acid) is an important factor in the production of poly(glycolic acid), and when the molecular weight distribution is less than 1.5, precise control of polymerization conditions is required, which may cause difficulties in economical product production. In addition, when the molecular weight distribution of the poly(glycolic acid) is greater than 4.5, there may be a problem that decomposition is accelerated during melt processing due to low molecular weight poly(glycolic acid). More preferably, the molecular weight distribution of the poly(glycolic acid) is 2.0 to 4.0.

The gas barrier layer may include various polymers in addition to poly(glycolic acid), and preferably includes poly(butylene adipate-co-terephthalate) (PBAT). More preferably, the gas barrier layer includes poly(glycolic acid) and poly(butylene adipate-co-terephthalate), and includes them in an amount of 40 to 60 vol % and 60 to 40 vol %, respectively, based on the total volume of the gas barrier layer. Preferably, the weight average molecular weight of the poly(butylene adipate-co-terephthalate) is 90,000 to 180,000. If the weight average molecular weight of the poly(butylene adipate-co-terephthalate) is less than 90,000, there may be a problem where the mechanical properties of the produced film may be significantly deteriorated, and difficulties may occur in processes such as film molding due to low melt viscosity. If the weight average molecular weight of the poly(butylene adipate-co-terephthalate) is greater than 180,000, it may be difficult to effectively melt the resin in the extrusion molding process.

The term “substrate layer (Ts)” as used herein serves to support the gas barrier layer, wherein the gas barrier layer is formed on the substrate layer. Preferably, the substrate layer is made of biodegradable polyester or a mixture thereof. Examples of the biodegradable polyester include poly(butylene adipate-co-terephthalate) (PABT), polylactic acid (PLA), and polybutylene succinate (PBS). Preferably, the weight average molecular weight of the poly(butylene adipate-co-terephthalate) is 90,000 to 180,000, the weight average molecular weight of the polylactic acid is 110,000 to 190,000, and the weight average molecular weight of the polybutylene succinate is 120,000 to 200,000.

In particular, the gas barrier multilayer film according to the present disclosure is characterized by satisfying the above Mathematical Formula 1. The Mathematical Formula 1 means the ratio of the thickness between the gas barrier layer and the substrate layer, and is expressed as “D(Tb)/D(Ts)”. If the D(Tb)/D(Ts) value is less than 0.38, the thickness of the gas barrier layer is made into a very thin film during melt processing, which may cause a problem of significant deterioration of the gas barrier properties. In addition, if the D(Tb)/D(Ts) value is 4.89 or more, there is a problem that the thickness of the substrate layer is made into a thin film at a considerable level, which significantly reduces the melt adhesive strength between films, making it difficult to produce packaging materials. In the case of the gas barrier layer, there may be a problem that it is difficult to realize an economically appropriate gas barrier layer due to the problem of being made into a thick film.

On the other hand, the thickness of the gas barrier layer is 10 to 500 μm, preferably 5 to 50 μm. In addition, the thickness of the substrate layer is 8 to 450 μm, preferably 5 to 60 μm.

Preferably, the gas barrier multilayer film according to the present disclosure satisfies the following Mathematical Formula 2:

0.01≤OTR(Tb)/OTR(Ts)≤0.52 [Mathematical Formula 2]
where OTR(Tb) is the oxygen transmission rate of the gas barrier layer, and
OTR(Ts) is the oxygen transmission rate of the substrate layer.

The Mathematical Formula 2 represents the ratio of the oxygen permeability between the gas barrier layer and the substrate layer, and is expressed as “OTR(Tb)/OTR(Ts)”. The unit of the oxygen permeability is “cc/m²·day·kPa”, and the measurement method thereof is specifically described in the Examples provided hereinafter. If the OTR(Tb)/OTR(Ts) value is less than 0.01, a problem occurs where a multilayer film is difficult to obtain due to a decrease in the mechanical properties of the gas barrier layer, and if the OTR(Tb)/OTR(Ts) value is greater than 0.52, a problem occurs where the substrate layer is peeled off during deformation of the multilayer film due to the substrate layer being made into a thin film, and the it is therefore difficult to obtain an economically effective gas barrier layer due to excessive thickening of the gas barrier layer.

Preferably, the gas barrier multilayer film according to the present disclosure satisfies the following Mathematical Formula 3:

0.014≤WVTR(Tb)/WVTR(Ts)≤0.61 [Mathematical Formula 3]
where WVTR(Tb) is the water vapor transmittance rate of the gas barrier layer, and
WVTR(Ts) is the water vapor transmittance rate of the substrate layer.

The Mathematical Formula 3 represents the ratio of the water vapor transmittance between the gas barrier layer and the substrate layer, and is expressed as “WVTR(Tb)/WVTR(Ts)”. The unit of the water vapor transmittance is “g/m²·day”, and the measurement method thereof is specifically described in the Examples provided hereinafter. If the WVTR(Tb)/WVTR(Ts) value is less than 0.014, a problem occurs where it is difficult to obtain a multilayer film due to a decrease in the mechanical properties of the gas barrier layer, and if the WVTR(Tb)/WVTR(Ts) value is greater than 0.61, a problem may occur similar to the problem described with respect to oxygen permeability mentioned above, where the substrate layer is peeled off during deformation of the multilayer film due to the substrate layer being made into a thin film, and therefore it is difficult to obtain an economically effective gas barrier layer due to the excessive thickening of the gas barrier layer.

On the other hand, the gas barrier multilayer film according to the present disclosure may further include various layers as necessary in addition to the substrate layer and gas barrier layer described above. That is, the gas barrier multilayer film according to the present disclosure may further include an additional substrate layer, an additional gas barrier layer, or an inorganic layer. For example, on the gas barrier multilayer film including the substrate layer and the gas barrier layer, an additional substrate layer may be included for protecting the gas barrier layer, or a substrate layer and a gas barrier layer may be further included to further enhance the gas barrier effect, or an inorganic layer may be added for the purpose of improving the print visibility of the packaging material or improving the slip properties of a film, thereby preventing film roll blocking. These examples are schematically represented as follows. At this time, the substrate layer and the gas barrier layer are as described above, and the inorganic layer means TiO₂, aluminum oxide, silicon oxide, etc.
substrate layer/gas barrier layer/substrate layer
substrate layer/gas barrier layer/inorganic layer/substrate layer
substrate layer/gas barrier layer/substrate layer/gas barrier layer
substrate layer/gas barrier layer/substrate layer/gas barrier layer/substrate layer

In addition, according to the present disclosure, there is provided a method for manufacturing a gas barrier multilayer film according to the present disclosure, the method comprising: a step 1 of producing a substrate layer and a gas barrier layer film respectively, and a step 2 of laminating each film produced in step 1.

In the step 1, the gas barrier multilayer film can be produced by melting the components constituting the substrate layer and the gas barrier layer to produce a film, and for example, the gas barrier multilayer film can be produced by a blown film process. In the step 2, the gas barrier multilayer film can be produced by laminating each film produced in the above step 1 and then laminating the gas barrier multilayer film using a hot press or the like.

As set forth above, a gas barrier multilayer film according to the present disclosure is biodegradable and, at the same time, has excellent gas barrier properties. When applied to food packaging materials, the gas barrier multilayer film has the advantage of enabling long-term storage and distribution of food due to its excellent gas barrier properties. In addition, due to its characteristic of being biodegradable in soil and marine conditions, the gas barrier multilayer film can be utilized as a biodegradable eco-friendly packaging material.

Hereinafter, exemplary embodiments of the present disclosure will be described in more detail with reference to the following examples. However, the following examples are provided for illustrative purposes only, and the scope of the present disclosure is not intended to be limited thereby.

### Production Example

Respective polymer blends were produced in the ratios shown in Table 1 below, using a Co-rotating Intermeshing Twin Screw Extruder (BA-19, Bautek) having a screw diameter of 19 mm, an aspect ratio (L/D, Length/Diameter) of 40, and 7 Heating Barrel.

Specifically, the barrel temperature was sequentially set from 180 °C to 230 °C at 20 °C intervals, and the strand extruded under conditions of 200 rpm and 3 kg/hr feeding was cooled in a 20 °C water bath and passed through a pelletizer to produce a polymer blend pellet.

In the case of composition #8, the polymer blend pellet was produced under the same conditions, except that the barrel temperature was sequentially set from 140 °C to 190 °C at 20 °C intervals. At this time, Joncryl ADR 4401 (BASF) was used as a compatibilizer to increase compatibility between resins, and 1.0 phr was added to compositions #1 to #7, #9 and #10, and 0.1 phr was added to composition #8, respectively.

In addition, 0.1 phr of PEP 36 (ADEKA) as a pentaerythritol-based antioxidant was added to compositions #1 to #7, #9 and #10 to improve thermal stability. In addition, in order to produce a polymer composite containing inorganic substances, 30 wt. % of TiO₂ (Sigma Aldrich) was added to poly(butylene adipate-co-terephthalate) (PABT) under the conditions of sequentially setting the barrel temperature from 140 °C to 190 °C at 20 °C intervals, 200 rpm, and 3 kg/hr feeding.

TABLE 1

| | Product | | | | | | | | | | | |
|---|---|---|---|---|---|---|---|---|---|---|---|---|
| | name | Composition (vol %) | | | | | | | | | | |
| Polymer | (Manufacturer) | #1 | #2 | #3 | #4 | #5 | #6 | #7 | #8 | #9 | #10 | #11 |
| PGA | MI15 | 100 | 65.6 | 55.1 | 45.0 | 35.3 | 17.0 | 0 | — | — | 55.1 | 55.1 |
| | (Samyang) | | | | | | | | | | | |
| PBAT | Ecoflex | 0 | 34.4 | 44.9 | 55.0 | 64.7 | 83.0 | 100 | 80 | — | — | — |
| | C1200 | | | | | | | | | | | |
| | (BASF) | | | | | | | | | | | |
| PLA | 4032D | — | — | — | — | — | — | — | 20 | — | — | — |
| | (Nature | | | | | | | | | | | |
| | Works) | | | | | | | | | | | |
| PBS | FZ79AC | — | — | — | — | — | — | — | — | 100 | — | — |
| | (PTT- | | | | | | | | | | | |
| | MCC) | | | | | | | | | | | |
| PET | SKYPET | — | — | — | — | — | — | — | — | — | 44.9 | — |
| | BL8050 | | | | | | | | | | | |
| | (SK | | | | | | | | | | | |
| | Chemicals) | | | | | | | | | | | |
| PBT | KH2100A | — | — | — | — | — | — | — | — | — | — | 44.9 |
| | (HENGLI) | | | | | | | | | | | |

### Example and Comparative Example

For each composition produced in the Production Example, a film with a thickness of 30 μm was produced under the conditions of 230 °C, 60 rpm, and BUR (Blow-up Ratio) 1.3 using a blown film machine (30 mm Air Die, Collin). However, for the composition #8 and the inorganic composite, a film with a thickness of 30 μm was produced under the conditions of 170 °C, 60 rpm, and BUR (Blow-up Ratio) 1.3.

The produced film was laminated with the configurations shown in Table 2 and Table 3 below, and then a multilayer film was produced using a Hot Press (Wabash, US) under the conditions of 40 °C, 5 MPa, and 6 minutes.

The evaluations below were performed on each produced multilayer film, and are shown in Tables 2 to 4 below.

### (1) Oxygen Transmittance Rate (OTR)

For each film, the Oxygen Transmittance Rate (OTR) was measured for 2 days using the OTR (Oxygen Transmittance Rate) device from Systech Illinois at a temperature of 23 °C and ΔP of 1 atm.

### (2) Water Vapor Transmittance Rate (WVTR)

For each film, the Water Vapor Transmittance Rate(WVTR) was measured for 2 days using the AquaSense 7101 WVTR (Water Vapor Transmittance Rate) device from Systech Illinois at a temperature of 37.8 °C and a relative humidity of 90%. When the oxygen transmission rate of each film was measured at a high level of 100 cc/m²·day·kPa or higher, the water vapor transmittance rate was not measured.

TABLE 2

| Item | Ex. 1 | Ex. 2 | Ex. 3 | Ex. 4 | Ex. 5 | Ex. 6 |
|---|---|---|---|---|---|---|
| Layer | 2 | 2 | 2 | 2 | 2 | 2 |
| Number | | | | | | |
| Layer 1 | #3 | #3 | #3 | #4 | #4 | #4 |
| Layer 2 | #8 | #7 | #9 | #8 | #7 | #9 |
| OTR(cc/m² · day · kPa) | 3 | 4 | 2 | 4 | 5 | 4 |
| WVTR(g/m² · day) | 4 | 4 | 3 | 6 | 6 | 4 |

TABLE 3

| | Compar- | Compar- | Compar- | Compar- | Compar- | Compar- | Compar- | Compar- |
|---|---|---|---|---|---|---|---|---|
| | ative | ative | ative | ative | ative | ative | ative | ative |
| Item | Ex. 1 | Ex. 2 | Ex. 3 | Ex. 4 | Ex. 5 | Ex. 6 | Ex. 7 | Ex. 8 |
| Layer | 1 | 1 | 1 | 1 | 1 | 2 | 2 | 2 |
| Number | | | | | | | | |
| Layer 1 | #3 | #6 | #7 | #8 | #9 | #7 | #10 | #11 |
| Layer 2 | — | — | — | — | — | #3 | #8 | #8 |
| OTR | 15 | 103 | 109 | 117 | 29 | 20 | Failure¹⁾ | Failure |
| (cc/m² · day · kPa) | | | | | | | | |
| WVTR | 16 | — | — | — | 33 | 24 | Failure | Failure |
| (g/m² · day) | | | | | | | | |

¹⁾Failure: The compatibility between polymers decreased, and film production was not possible.

TABLE 4

| | | | | | Comparative | Comparative |
|---|---|---|---|---|---|---|
| Item | Ex. 7 | Ex. 8 | Ex. 9 | Ex. 10 | Ex. 9 | Ex. 10 |
| Layer | 3 | 4 | 5 | 6 | 3 | 3 |
| Number | | | | | | |
| Layer 1 | #9 | #9 | #9 | #9 | #9 | #8 |
| Layer 2 | #3 | Inorganic | #3 | Inorganic | #8 | #9 |
| | | layer | | layer | | |
| Layer 3 | #8 | #3 | #8 | #3 | #9 | #8 |
| Layer 4 | — | #8 | #3 | #8 | — | — |
| Layer 5 | — | — | #8 | #3 | — | — |
| Layer 6 | — | — | — | #8 | — | — |
| OTR | 3 | 2 | <1 | <1 | 21 | 44 |
| (cc/m² · day · kPa) | | | | | | |
| WVTR | 4 | 2 | 1 | <1 | 22 | 51 |
| (g/m² · day) | | | | | | |

1. A gas barrier multilayer film comprising a substrate layer (Ts); and a gas barrier layer (Tb) formed on the substrate layer,
wherein the gas barrier layer (Tb) comprises poly(butylene adipate-co-terephthalate) and poly(glycolic acid), and comprises 40 to 60 vol % of poly(glycolic acid) based on a total volume of the gas barrier layer, and
the gas barrier multilayer film satisfies the following Mathematical Formula 1:
0.38≤D(Tb)/D(Ts)<4.89 [Mathematical Formula 1]
in Mathematical Formula 1,
where D(Tb) is the thickness of the gas barrier layer, and
D(Ts) is the thickness of the substrate layer.

2. The gas barrier multilayer film according to claim 1, wherein:
the gas barrier multilayer film satisfies the following Mathematical Formula 2:
0.01≤OTR(Tb)/OTR(Ts)≤0.52 [Mathematical Formula 2]
where OTR(Tb) is the oxygen transmission rate of the gas barrier layer, and
OTR(Ts) is the oxygen transmission rate of the substrate layer.

3. The gas barrier multilayer film according to claim 1, wherein:
the gas barrier multilayer film satisfies the following Mathematical Formula 3:
0.014≤WVTR(Tb)/WVTR(Ts)≤0.61 [Mathematical Formula 3]
where WVTR(Tb) is the water vapor transmittance rate of the gas barrier layer, and
WVTR(Ts) is the water vapor transmittance rate of the substrate layer.

4. The gas barrier multilayer film according to claim 1, wherein:
the gas barrier layer comprises poly(glycolic acid) and poly(butylene adipate-co-terephthalate) in an amount of 40 to 60 vol % and 60 to 40 vol %, respectively, based on the total volume of the gas barrier layer.

5. The gas barrier multilayer film according to claim 1, wherein:
the substrate layer is made of a biodegradable polyester or a mixture thereof.

6. The gas barrier multilayer film according to claim 5, wherein:
the biodegradable polyester is poly(butylene adipate-co-terephthalate) (PABT), polylactic acid (PLA), or polybutylene succinate (PBS).

7. The gas barrier multilayer film according to claim 1, wherein:
the thickness of the gas barrier layer is 5 to 50 μm.

8. The gas barrier multilayer film according to claim 1, wherein:
the thickness of the substrate layer is 5 to 60 μm.

9. The gas barrier multilayer film according to claim 1, wherein:
the gas barrier multilayer film further comprises an additional substrate layer, an additional gas barrier layer, or an inorganic layer.
